(19) United States
(12) Patent Application Publication
(10) Pub. No.: US 2021/0378264 A1
(43) Pub. Date: Dec. 9, 2021

(54) PACKAGED FROZEN DRINK BASE

(71) Applicant: Real Peel Inc., London (CA)

(72) Inventor: Cayleah J MATTHEWS, London (CA)

(73) Assignee: Real Peel Inc., London (CA)

(21) Appl. No.: 17/143,368

(22) Filed: Jan. 7, 2021

Related U.S. Application Data
(60) Provisional application No. 63/035,388, filed on Jun. 5, 2020.

(51) Int. Cl. A23L 2/02; A23L 2/60; A23L 33/105; A23L 2/42; A23L 2/385; A23L 3/36; B65D 75/12

(52) U.S. Cl. CPC A23L 2/02; A23L 2/60; A23L 33/105; A23V 2002/00; A23L 2/385; A23L 3/36; B65D 75/12; A23L 2/42

(57) ABSTRACT

A packaged frozen drink base contains an unpasteurized frozen aqueous antioxidant composition having a pH of 4 or less and packaging formed of a sealed waterproof tube having the frozen aqueous antioxidant composition disposed therein. The aqueous antioxidant composition contains at least one citrus juice which is at least lemon juice, at least one natural sweetener, and turmeric root extract in an amount of 0.5-1.2 mL per 10 mL of the aqueous antioxidant composition or green tea leaf extract in an amount of 3-6 mL per 10 mL of the aqueous antioxidant composition. The packaging can be opened and the aqueous antioxidant composition dissolved in water to provide a tasty antioxidant beverage that has beneficial health effects.

### CROSS-REFERENCE TO RELATED APPLICATIONS

This application claims the benefit of United States Provisional Patent Application U.S. Ser. No. 63/035,388 filed Jun. 5, 2020, the entire contents of which is herein incorporated by reference.

### FIELD

This application relates to a packaged frozen drink base, a method of preparing a beverage from the packaged frozen drink base and a beverage prepared thereby.

### BACKGROUND

Compounds with antioxidant activity are believed to contribute to protection against various diseases and conditions, for example degenerative and cardiovascular diseases, in humans and animals. There have been many attempts to combine different antioxidants into health products, including ingestible health products, especially for humans. Ingestible health products are particularly advantageous as they could be readily acquired and consumed by the general population. However, a number of difficulties arise with ingestible health products containing a variety of antioxidant compounds from different sources including degradation of antioxidant activity during preparation and storage, appropriate packaging for ease of use in a desirable format, agreeable flavor and preservation of the agreeable flavor.

One of the main determiners of consumer acceptance of any ingestible product is flavor. Flavor arises from a complex interaction between all of the components of the product. As components are introduced into a composition, the flavor of the composition can change dramatically. Thus, while taste acceptability is relative within a population, flavor patterns and patterns of preference can only be ascertained by experimentation.

There remains a need for ingestible health products that have acceptable flavors and beneficial antioxidant health effects, and that are packaged to preserve the flavors and antioxidant health effects over a long storage period while being simple to serve in a beverage format.

### SUMMARY

A packaged frozen drink base comprises: (a) an unpasteurized frozen aqueous antioxidant composition having a pH of 4 or less, the aqueous antioxidant composition comprising: at least one citrus juice; at least one natural sweetener; and, turmeric root extract or green tea leaf extract; and, (b) packaging containing the unpasteurized frozen aqueous antioxidant composition, the packaging comprising a sealed waterproof tube having the aqueous antioxidant composition disposed therein.

The packaged frozen drink base may comprise: (a) an unpasteurized frozen aqueous antioxidant composition having a pH of 4 or less, the aqueous antioxidant composition comprising: at least one citrus juice comprising at least lemon juice; at least one natural sweetener; and, turmeric root extract in an amount of 0.5-1.2 mL per 10 mL of the aqueous antioxidant composition, or green tea leaf extract in an amount of 3-6 mL per 10 mL of the aqueous antioxidant composition; and, (b) packaging containing the unpasteurized frozen aqueous antioxidant composition, the packaging comprising a sealed waterproof tube having the aqueous antioxidant composition disposed therein.

The packaged frozen drink base may comprise: (a) an unpasteurized frozen aqueous antioxidant composition having a pH of 4 or less, the aqueous antioxidant composition consisting of: (i) a blueberry green tea (BGT) formulation consisting of citrus juice consisting of lemon juice and lime juice in an amount of 0.5-2.2 mL per 10 mL of the aqueous antioxidant composition, blueberry juice in an amount of 2.5-7.5 mL per 10 mL of the aqueous antioxidant composition, at least one natural sweetener in a v/v ratio of 3:1 to 6:1 citrus juice to sweetener, mint leaf extract, and green tea leaf extract in an amount of 3-6 mL per 10 mL of the aqueous antioxidant composition, or (ii) a lemon ginger turmeric (LGT) formulation consisting of citrus juice consisting of lemon juice in an amount of 6-8 mL per 10 mL of the aqueous antioxidant composition, at least one natural sweetener in a v/v ratio of 3:1 to 6:1 citrus juice to sweetener, ginger root extract in an amount of 0.1-0.55 mL per 10 mL of the aqueous antioxidant composition, and turmeric root extract in an amount of 0.5-1.2 mL per 10 mL of the aqueous antioxidant composition; and, (b) packaging containing the unpasteurized frozen aqueous antioxidant composition, the packaging comprising a sealed waterproof tube having the aqueous antioxidant composition disposed therein, the sealed waterproof tube having an aspect ratio of length to largest diameter of at least 4:1.

A beverage can be prepared from the packaged frozen drink base by opening the packaging of the drink base and dissolving the aqueous antioxidant composition in water.

The frozen aqueous antioxidant composition provided herein is an ingestible natural health product having beneficial effects through antioxidant activity of components of the composition, while being tailored to provide an acceptable flavor profile for consuming in a beverage. The beverage thereby has beneficial health effects and is tasty to drink. The combination of components in the aqueous antioxidant composition has been found to provide a tastier beverage than similar compositions. Freezing the aqueous antioxidant composition at a pH of 4 or less in a sealed waterproof tube preserves the flavor, color and antioxidant efficacy of the various components. Thus, a consumable product that has an acceptable flavor and beneficial antioxidant health effects, the present product provides for a tasty and healthy beverage, and is packaged to preserve the flavor and antioxidant health effects over a long storage period while being simple to serve in a beverage format.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a packaged frozen drink base of the present invention.

### DETAILED DESCRIPTION

The aqueous antioxidant composition is designed to be both beneficial to health and flavorful to drink. The composition is formulated and packaged in such a way as to preserve the flavor, color and health benefits of the composition, and to provide a simple method for preparing the beverage from the composition. It has been found that the antioxidant activity and agreeable flavor of the composition can be well preserved by employing a combination of:
specific recipes of compositional components to provide sufficiently low pH and high vitamin C content while providing acceptable flavor profile;
rapid processing of the compositional components to minimize air contact to avoid antioxidant degradation by UV light, high heat and/or high pressure;
not pasteurizing the juices and/or the aqueous antioxidant composition to avoid antioxidant degradation by UV light, high heat and/or high pressure; and,
rapidly freezing the composition, which is facilitated by high aspect ratio packaging that increases the surface area to volume ratio of the aqueous antioxidant composition in the sealed waterproof tube.
   Further, high aspect ratio packaging additionally facilitates the insertion of the package through a narrow open end of a typical water bottle to be able to simply prepare the beverage in the water bottle. Furthermore, the citrus juice and fruit juice components of the aqueous antioxidant composition are freshly prepared from whole fruit, for example by cold pressing, and the juices obtained are not concentrated before use in the aqueous antioxidant composition.

The packaged frozen drink base can be produced in an automated process that maintains antioxidant effectiveness, maintains food safety (which is very difficult to achieve with unpasteurized products as freezing alone is not adequate to achieve food safety), and provides consumer acceptance. To create a beverage flavorant that is easy to use, tastes great, has no added sugar, has a good price point (due to automated manufacturing), and contains effective antioxidants has been heretofore very difficult to find in a shelf-stable product. The present drink base succeeds in this regard.

The packaging containing the unpasteurized frozen aqueous antioxidant composition comprises a sealed waterproof tube having the aqueous antioxidant composition disposed therein. The waterproof tube has an aspect ratio of length to largest diameter of at least 4:1. The aspect ratio of the packaging is important and has at least four functions that cooperate to provide a packaged frozen drink base that can enjoy commercial success. The at least four functions of the aspect ratio include: permits faster freezing due to increased surface area resulting in better antioxidant and flavor retention; permits automatic manufacturing with existing, though somewhat modified, flash freezing machines; permits insertion of the packaged frozen drink base, whether frozen or thawed, into an open mouth of a container, especially a narrow-mouthed container such as a standard water bottle; and, permits more rapid dissolution of the aqueous antioxidant composition in water due to the higher surface area. The aspect ratio is preferably at least 5:1, more preferably at least 6:1, for example about 6.5:1. The waterproof tube is preferably made of a flexible film to facilitate filling the tube with the aqueous antioxidant composition and emptying the tube with the aid of squeezing the tube. Preferably, the waterproof tube can be torn open by hand, for example at a portion made amenable to tearing, or cut open with scissors or a knife to facilitate opening the packaging for use in preparing the beverage. Preferably, the waterproof tube is readily disposable after use. The waterproof tube is preferably compostable. The waterproof tube is freezable, especially by flash freezing, without damaging the structural integrity of the tube. The waterproof tube is preferably made in whole or in part with a plastic material. The waterproof tube is preferably made from a film of plastic material that has been formed into a tube, which can be filled with the aqueous antioxidant composition and sealed, for example by heat sealing, and then frozen with the aqueous antioxidant composition inside the sealed tube. The plastic material preferably comprises a thermoplastic, for example polyethylene, polypropylene, polyethylene terephthalate, blends thereof or copolymers thereof. The plastic material preferably comprises polyethylene terephthalate/polyethylene 65 (PET/PE65).

Freezing the aqueous antioxidant composition inside the sealed waterproof tube is preferably accomplished by flash freezing. Flash freezing preferably involves freezing the entire volume of aqueous antioxidant composition within a time of 20 minutes or less, more preferably 15 minutes or less. Flash freezing is preferably accomplished by exposing the sealed waterproof tubes filled with liquid aqueous antioxidant composition to a temperature in a range of −20° to −30° C., more preferably −25° to −28° C. In one embodiment, the filled and sealed tubes may be moved through a cooling liquid bath (e.g. a propylene glycol bath) at the desired freezing temperature and exposed to the cold temperatures for sufficient time to freeze the entire volume of aqueous antioxidant composition. Flash freezing may be facilitated by using a metal freezing apparatus, which is sitting inside the cooling bath and on which the filled and sealed tubes are supported. Metal surfaces of the apparatus help remove heat from the filled tubes until the aqueous antioxidant compositions are frozen solid inside the sealed tubes. The high aspect ratio of the sealed tubes increases the surface area to volume ratio of the aqueous antioxidant compositions permitting rapid flash freezing.

The aqueous antioxidant compositions consist of all-natural components; therefore, the aqueous antioxidant compositions are natural health products. There is no added sugar in the aqueous antioxidant compositions.

The blueberry green tea (BGT) formulation consists of citrus juice consisting of lemon juice and lime juice in an amount of 0.5-2.2 mL per 10 mL of the aqueous antioxidant composition, blueberry juice in an amount of 2.5-7.5 mL per 10 mL of the aqueous antioxidant composition, at least one natural sweetener in a v/v ratio of 3:1 to 6:1 citrus juice to sweetener, mint leaf extract, and green tea leaf extract in an amount of 3-6 mL per 10 mL of the aqueous antioxidant composition. The green tea (Camellia sinensis) is preferably sourced from an organic grower. The green tea extract is preferably prepared by brewing green tea leaves in boiling water in a ratio of 70-120 mL of boiling water to 10 g of the green tea for 5-20 minutes, and then preferably cold-steeped after the addition of another 100-200 mL of water, preferably overnight. After cold-steeping, the green tea extract may be filtered to remove residual tea leaves, and the residual tea leaves pressed to further extract all brewed tea. The at least one natural sweetener is present in the BGT formulation in an amount of 0.2-0.5 mL per 10 mL of the aqueous antioxidant composition. The at least one natural sweetener preferably comprises monk fruit extract, more preferably consists of monk fruit extract. The amount of citrus juice in the BGT formulation is preferably 1.65-1.9 mL per 10 mL of the aqueous antioxidant composition. The citrus juice is preferably prepared by squeezing out the juices from fresh citrus fruit, preferably in a slow juicing apparatus. The blueberry juice is preferably wild blueberry juice. The blueberry juice is preferably prepared by squeezing out the juices from fresh blueberries, preferably in a single-auger slow juicing apparatus. The mint is preferably employed as an extract in the lemon juice, the mint being extracted by blending fresh leaf in the lemon juice followed by filtering out the residual leaf material. All of the prepared components are mixed together in a mixer to form the BGT aqueous antioxidant composition.

The lemon ginger turmeric (LGT) formulation consists of citrus juice consisting of lemon juice in an amount of 6-8 mL per 10 mL of the aqueous antioxidant composition, at least one natural sweetener in a v/v ratio of 3:1 to 6:1 citrus juice to sweetener, ginger root extract in an amount of 0.1-0.55 mL per 10 mL of the aqueous antioxidant composition, and turmeric root extract in an amount of 0.5-1.2 mL per 10 mL of the aqueous antioxidant composition; and, (b) packaging containing the unpasteurized frozen aqueous antioxidant composition. The amount of turmeric root extract is preferably 0.6-1 mL per 10 mL. The amount of ginger root extract plus the amount of turmeric root extract is preferably 1.5 mL or less per 10 mL of the aqueous antioxidant composition. The turmeric root extract is preferably in a v/v ratio of 1.1:1 to 1.4:1 with respect to the ginger root extract. The root extracts (turmeric (Curcuma longa) and ginger extracts) are preferably prepared by extracting juices from fresh root, for example by using a single-auger slow juicer. The extraction is preferably conducted for about 10-30 minutes, for example 20 minutes. The slow juicer reduces exposure of the turmeric and ginger juices to heat and oxygen. Freshly prepared turmeric root extract and ginger root extract are preferred. The at least one natural sweetener is preferably present in an amount of 1.5-1.8 mL per 10 mL of the aqueous antioxidant composition. The at least one natural sweetener preferably comprises monk fruit extract, more preferably consists of monk fruit extract. The amount of citrus juice is preferably 7.0-7.6 mL per 10 mL of the aqueous antioxidant composition. The citrus juice is preferably prepared by squeezing out the juices from fresh lemon, preferably in a slow juicing apparatus.

Acidity of the aqueous antioxidant composition has an effect on the stability of antioxidant components. When the pH of the aqueous antioxidant composition is 4 or less, the antioxidant components are more stable than in aqueous compositions of higher pH. Preferably, the pH is 3 or less.

The sense of taste can be divided into five basic tastes: bitter, salty, sweet, umami (savoury) and sour. For drink bases described herein containing at least one natural sweetener and citrus juice, sweetness and sourness are particularly important. Where the drink base also contains the turmeric root extract, savouryness becomes relatively important, while in drink bases also containing green tea leaf extract, bitterness becomes relatively important. Thus, the amounts of turmeric root extract and green tea leaf extract are factors in creating aqueous antioxidant composition having acceptable flavor profiles. Further, the relative amounts of the citrus juice and the at least one natural sweetener can also contribute to acceptable flavor profiles, as well as the absolute amounts of the citrus juice and the at least one natural sweetener in the aqueous antioxidant composition. As further and further components are added to the aqueous antioxidant composition, or as the amount of the components is changed, the flavor of the composition can change dramatically. Thus, patterns of preference can only be ascertained after experimentation.

Perception of sweet and sour is dictated by a complex relationship between all of the components in the aqueous antioxidant composition, especially the amounts of the at least one citrus juice and the at least one natural sweetener. While increased amounts of citrus juice may contribute to a sour taste and increased amounts of sweetener may contribute to a sweeter taste, the interaction between the two components is not linear and can lead to unexpected taste results. In the aqueous antioxidant composition, the at least one citrus juice and the at least one natural sweetener are preferably present in a v/v ratio of 3:1 to 6:1 citrus:sweetener.

In aqueous antioxidant compositions with turmeric root extract, turmeric root extract is present in an amount of 0.5-1.2 mL per 10 mL of the aqueous antioxidant composition in order to provide sufficient antioxidant effectiveness while not overpowering the taste with an overly rooty flavor. Preferably, the turmeric root extract is present in an amount of 0.6-1 mL per 10 mL of aqueous antioxidant composition. Along with the turmeric root extract, ginger root extract is also present and the total amount of root extracts is preferably 1.5 mL or less per 10 mL of the aqueous antioxidant composition, more preferably 1.3 mL or less per 10 mL of the aqueous antioxidant composition. If the total amount of root extracts exceeds 1.5 mL per 10 mL of the aqueous antioxidant composition, the flavor becomes too ‘rooty’. Further, when the turmeric-containing aqueous antioxidant composition contains the at least one natural sweetener in an amount of 1.5-1.8 mL per 10 mL of the aqueous antioxidant composition and the citrus juice in an amount of 7.0-7.6 mL per 10 mL of the aqueous antioxidant composition, a particularly well balanced flavor is achieved that is neither too sweet nor too sour. Even when the ratio of citrus:sweetener remains the same by reducing or increasing the amounts of both the citrus and sweetener components, the particularly well-balanced flavor may be lost.

In aqueous antioxidant compositions with green tea extract, the balance of citrus juices and natural sweetener also determines whether the flavor is too sour, too sweet or acceptable. When the green tea-containing aqueous antioxidant composition contains the at least one natural sweetener in an amount of 0.2-0.5 mL per 10 mL of the aqueous antioxidant composition and the citrus juice in an amount of 1.65-1.9 mL per 10 mL of the aqueous antioxidant composition, a particularly well balanced flavor is achieved that is neither too sweet nor too sour. Even when the ratio of citrus:sweetener remains the same by reducing or increasing the amounts of both the citrus and sweetener components, the particularly well balanced flavor may be lost.

Antioxidant beverages can be prepared simply and efficiently from the packaged frozen drink base by diluting the aqueous antioxidant composition with water. The aqueous antioxidant composition dissolves quickly when mixed with water. The sealed waterproof tube may be opened before or after thawing, and the contents of the tube emptied into a container before or after thawing. The container is preferably a drinking container such as a water bottle, a cup, a tumbler or the like. The manner of opening of the sealed waterproof tube depends on the material of the packaging, but is preferably accomplished by cutting open the tube, preferably at one of the ends. The waterproof tube is preferably composed of a material that is readily cuttable by scissors or a knife, or has a portion amenable to tearing. The waterproof tube is preferably squeezable to aid in emptying the tube. The aqueous antioxidant composition can be emptied into the container followed by addition of the desired amount of water; or the aqueous antioxidant composition can be emptied into the container already containing the desired amount of water; or the aqueous antioxidant composition can be emptied into the container already containing a portion of the desired amount of water followed by the addition of another portion of the desired amount of water. The aqueous antioxidant composition is mixed with and dissolved in the water to form the beverage. The amount of water added depends on individual preference. Typically, 250-750 mL of water are added, with 250 mL providing a stronger beverage and 750 mL providing a weaker beverage.

### EXAMPLES

### Example 1—Lemon Ginger Turmeric (LGT)

Lemon Ginger Turmeric (LGT) aqueous antioxidant compositions shown in Table 1 were formulated using the procedure as described below and tested for pH. The compositions were subjected to a taste test. The results are shown in Table 2. As seen from Table 2, a balance between being not too sweet and not too sour while not being too rooty or too light requires a careful consideration of amounts of the citrus, sweetener and root components. In Table 2, where taste comments are blank, the flavor was found to be acceptable.

The following procedure was used to prepare the Lemon Ginger Turmeric (LGT) aqueous antioxidant compositions. Fresh whole lemons, ginger root, and turmeric root are removed from cold storage and washed for 45-60 seconds in an aqueous solution containing about 100 ppm peroxyacetic acid, followed by rinsing in tap water. Lemons are fed through a semi-automated juicer which presses the juice from the fruit, and the juice is collected. Ginger root is fed through a single-auger, slow juicer for about 20 minutes, which presses the juice from the root, and the juice is collected as a ginger root extract. Lemon juice, ginger root extract and monk fruit extract (used as obtained from the supplier) were measured out in accordance with the relative amounts shown in Table 1 and placed in a mixing vessel. Turmeric root (Curcuma longa, rhizome) is fed through a single-auger slow juicer for about 20 minutes, which presses the juice from the root and the juice is collected as a turmeric root extract. The slow juicer reduces exposure of the turmeric juice to heat and oxygen. Fresh turmeric root extract is added immediately to the mixing vessel and the ingredients mixed to form a mixture. The mixture of lemon juice, ginger root extract and monk fruit extract has a naturally derived pH at least as low as 2.7, which is stabilizing for the antioxidants in the mixture. All juices (i.e. lemon, ginger root, turmeric root) are sieved or filtered before being added to mixing vessel to reduce particulates.

TABLE 1
Lemon Ginger Turmeric (LGT) Formulations

| | Lemon | Ginger Root | Turmeric | Monk Fruit | Total |
|---|---|---|---|---|---|
| Sample | Juice | Extract | Root Extract | Extract | Volume |
| No. | (mL) | (mL) | (mL) | (mL) | (mL) |
| 1 | 15 | 2.5 | 2.5 | 3 | 23 |
| 2 | 15 | 2 | 2 | 3 | 22 |
| 3 | 14 | 2 | 2 | 3 | 21 |
| 4 | 10 | 1 | 1 | 0.556 | 12.556 |
| 5 | 10 | 1.5 | 1.5 | 0.555 | 13.555 |
| 6 | 12 | 1.5 | 1.5 | 0.555 | 15.555 |
| 7 | 14 | 1.5 | 1.5 | 0.555 | 17.555 |
| 8 | 14.76 | 2 | 2 | 0.31 | 19.07 |
| 9 | 5 | 0.625 | 0.625 | 1.25 | 7.5 |
| 10 | 10 | 1.25 | 1.25 | 1.875 | 14.375 |
| 11 | 7.5 | 1.25 | 1.25 | 1.875 | 11.875 |
| 12 | 10 | 1.25 | 1.25 | 2.5 | 15 |
| 13 | 7.5 | 0.9375 | 0.9375 | 1.875 | 11.25 |
| 14 | 8.75 | 1.25 | 1.25 | 1.875 | 13.125 |
| 15 | 11.25 | 1.25 | 1.25 | 2.5 | 16.25 |
| 16 | 7.5 | 1.25 | 1.25 | 1.875 | 11.875 |
| 17 | 10 | 1.25 | 1.25 | 2.5 | 15 |
| 18 | 7.5 | 0.9375 | 0.9375 | 1.875 | 11.25 |
| 19 | 11.25 | 1.25 | 1.25 | 1.875 | 15.625 |
| 20 | 7.5 | 0.95 | 0.95 | 1.875 | 11.275 |
| 21 | 8.75 | 1 | 1 | 1.875 | 12.625 |
| 22 | 8.75 | 1.25 | 1.25 | 1.875 | 13.125 |
| 23 | 11.2 | 1.2 | 1.2 | 1.2 | 14.8 |
| 24 | 12 | 1.2 | 1.33 | 1.4 | 15.93 |
| 25 | 11.2 | 1.2 | 1.2 | 1.2 | 14.8 |
| 26 | 11.2 | 1.2 | 1.2 | 0.8 | 14.4 |
| 27 | 12 | 1.2 | 1.33 | 1.4 | 15.93 |
| 28 | 12 | 1.2 | 1.33 | 1 | 15.53 |
| 29 | 12 | 1 | 1.3 | 1.4 | 15.7 |
| 30 | 12 | 0.5 | 0.65 | 1.4 | 14.55 |
| 31 | 12 | 0.75 | 1 | 1.4 | 15.15 |
| 32 | 6.5 | 0.5 | 0.65 | 1.4 | 9.05 |
| 33 | 11.25 | 1.25 | 1.25 | 1.5 | 15.25 |
| 34 | 11.25 | 1 | 1 | 1.5 | 14.75 |
| 35 | 11.25 | 1 | 1 | 1.25 | 14.5 |
| 36 | 10.75 | 0.9 | 1 | 1.25 | 13.9 |
| 37 | 10.75 | 0.9 | 0.9 | 1.5 | 14.05 |
| 38 | 11.25 | 0.9 | 1 | 1.5 | 14.65 |
| 39 | 11.25 | 0.9 | 1 | 1.75 | 14.9 |
| 40 | 12 | 0.9 | 1 | 2 | 15.9 |
| 41 | 12 | 0.9 | 1 | 1.75 | 15.65 |
| 42 | 12 | 0.9 | 1 | 2 | 15.9 |
| 43 | 11.25 | 0.9 | 1 | 1.5 | 14.65 |
| 44 | 11.25 | 0.9 | 1 | 2 | 15.15 |
| 45 | 12 | 0.7 | 0.91 | 1.96 | 15.57 |
| 46 | 9.1 | 0.7 | 0.91 | 1.96 | 12.67 |

TABLE 2
Lemon Ginger Turmeric (LGT) Results

| | | Citrus to | |
|---|---|---|---|
| Sample | | Monk Fruit | |
| No. | pH | Ratio | Taste Comments |
| 1 | 2.5 | 5.00 | too sweet; too concentrated |
| 2 | 2.5 | 5.00 | |
| 3 | 2.5 | 4.67 | |
| 4 | 2.52 | 18.00 | sour; not enough root |
| 5 | 2.52 | 18.02 | |
| 6 | 2.5 | 21.62 | |
| 7 | 2.5 | 25.23 | |
| 8 | 2.5 | 47.61 | heavy on roots; too sour |
| 9 | 2.7 | 4.00 | light; like ginger ale; good; too light in |
| | | | flavor and not enough of health food |
| 10 | 2.52 | 5.33 | a little agro on roots |
| 11 | 2.64 | 4.00 | a bit rooty but good; too rooty |
| 12 | 2.5 | 4.00 | too sweet |
| 13 | 2.64 | 4.00 | very drinkable; light |
| 14 | 2.63 | 4.67 | tasty; possibly equivalent roots favorable |
| 15 | 2.5 | 4.50 | too sweet |
| 16 | 2.64 | 4.00 | |
| 17 | 2.52 | 4.00 | too sweet |
| 18 | 2.64 | 4.00 | too sweet |
| 19 | 2.5 | 6.00 | |
| 20 | 2.64 | 4.00 | not enough flavor |
| 21 | 2.63 | 4.67 | ginger too strong |
| 22 | 2.63 | 4.67 | too rooty |
| 23 | 2.5 | 9.33 | |
| 24 | 2.5 | 8.57 | |
| 25 | 2.5 | 9.33 | |
| 26 | 2.5 | 14.00 | |
| 27 | 2.5 | 8.57 | better root ratio |
| 28 | 2.5 | 12.00 | |
| 29 | 2.5 | 8.57 | |
| 30 | 2.5 | 8.57 | good; too sour |
| 31 | 2.5 | 8.57 | good; a bit sour |
| 32 | 2.7 | 4.64 | |
| 33 | 2.5 | 7.50 | good; too rooty |
| 34 | 2.5 | 7.50 | ginger high |
| 35 | 2.5 | 9.00 | |
| 36 | 2.52 | 8.60 | not enough flavor |
| 37 | 2.52 | 7.17 | |
| 38 | 2.5 | 7.50 | |
| 39 | 2.5 | 6.43 | not enough flavor |
| 40 | 2.5 | 6.00 | |
| 41 | 2.5 | 6.86 | |
| 42 | 2.5 | 6.00 | too high ginger |
| 43 | 2.5 | 7.50 | |
| 44 | 2.5 | 5.63 | |
| 45 | 2.5 | 6.12 | |
| 46 | 2.6 | 4.64 | |

### Example 2—Wild Blueberry Green Tea (WBGT)

Wild Blueberry Green Tea (WBGT) aqueous antioxidant compositions shown in Table 3 were formulated using the procedure as described below. The compositions were subjected to a taste test. The results are shown in Table 4. As seen from Table 4, a balance between being not too sweet and not too sour while not being too light in flavor requires a careful consideration of amounts of the citrus, sweetener, blueberry and green tea components. In Table 4, where taste comments are blank, the flavor was found to be acceptable.

The following procedure was used to prepare the Wild Blueberry Green Tea (WBGT) aqueous antioxidant compositions. About 24 hours prior to producing the composition, Chinese Green Tea (Chun-Mee; Camellia sinensis, full leaf) is brewed by adding boiling water to organic green tea in a ratio of 83 mL of the boiling water to 9 g of the green tea. The tea is steeped for 10 mins, covered. After hot steeping, 166 mL of cold tap water is added, and the mixture is placed into cold storage overnight to continue cold-steeping. The following day, frozen wild blueberries are removed from frozen storage and washed in a about 100 ppm peroxyacetic acid solution for 45-60 seconds, followed by rinsing in tap water. Fresh whole lemons, limes and mint are removed from cold storage and washed in a about 100 ppm peroxyacetic acid solution for 45-60 seconds, followed by rinsing in tap water. Lemons and then limes are fed through a semi-automated juicer which presses the juice from the fruit, and the juices are collected separately. Lemon juice is measured out in accordance with the relative amounts shown in Table 3 and placed in a blender. The required amount of fresh mint leaves is added, the mixture blended, and then poured through a sieve to remove any large mint leaf pieces. Wild blueberries are fed through a single-auger slow juicer which presses the juice from the blueberries, which is collected. Lime juice, wild blueberry juice and monk fruit extract are measured out in accordance with the relative amounts shown in Table 3 and added to the blender containing the lemon juice and mint.

Green tea extract is removed from cold storage and the tea leaves sieved out and squeezed by hand to further extract all brewed tea. The green tea extract is measured out in accordance with the relative amounts shown in Table 3 and added to the blender. The mixture of lemon juice, lime juice, wild blueberry juice and monk fruit extract has a naturally derived pH at least as low as 3.0, which is stabilizing for the antioxidants in the mixture. All juices (i.e. wild blueberry, lemon, lime) are sieved or filtered before being added to mixing vessel to reduce particulates.

TABLE 3
Wild Blueberry Green Tea (WBGT) Formulations

| | Wild | | | Green Tea | Monk Fruit | | |
|---|---|---|---|---|---|---|---|
| Sample | Blueberry | Lemon | Lime | Extract | Extract | Mint | Total |
| No. | (mL) | (mL) | (mL) | (mL) | (mL) | (leaf size) | (mL) |
| 47 | 10 | 2 | 0.675 | 10 | 1.3 | ¼ leaf | 23.975 |
| 48 | 10 | 3.17 | 0.92 | 10 | 1.3 | ¼ leaf | 25.39 |
| 49 | 9 | 2.9 | 0.8 | 10 | 1.2 | ¼ leaf | 23.9 |
| 50 | 7 | 2.5 | 2.5 | 10 | 1.04 | | 23.04 |
| 51 | 2.5 | 1.25 | | 7.5 | 0.875 | | 12.125 |
| 52 | 6 | 2.625 | | 5 | 1 | | 14.625 |
| 53 | 3 | 1.25 | 1.25 | 6 | 0.52 | | 12.02 |
| 54 | 3 | 1.25 | 1.25 | 5 | 0.52 | ¼ leaf | 11.02 |
| 55 | 8.7 | 2.5 | 1.875 | 10 | 0.9375 | small | 24.0125 |
| 56 | 10 | 1.25 | | 10 | 0.675 | | 21.925 |
| 57 | 10 | 1.925 | | 10 | 1.25 | large | 23.175 |
| 58 | 2.5 | 1.25 | | 7.5 | 0.875 | | 12.125 |
| 59 | 7 | 2.5 | 2.5 | 10 | 1.04 | | 23.04 |
| 60 | 6 | 2.5 | 1.25 | 12 | 0.625 | | 22.375 |
| 61 | 6 | 2.5 | 2.5 | 10 | 1.04 | ¼ leaf | 22.04 |
| 62 | 10 | 2.5 | | 10 | 1.35 | | 23.85 |
| 63 | 7 | 2.5 | | 10 | 0.75 | small | 20.25 |
| 64 | 7 | 2.5 | | 10 | 1 | | 20.5 |
| 65 | 7 | 2.5 | | 10 | 1.25 | | 20.75 |
| 66 | 7 | 2.5 | | 10 | 1.5 | | 21 |
| 67 | 8 | 2.5 | | 10 | 1 | | 21.5 |
| 68 | 8 | 2 | 0.25 | 10 | 1 | | 21.25 |
| 69 | 8 | 2 | 0.5 | 10 | 1 | | 21.5 |
| 70 | 8 | 2 | 0.75 | 10 | 1 | | 21.75 |
| 71 | 9 | 1 | 1.5 | 10 | 1 | small | 22.5 |
| 72 | 9 | 1.25 | 1.25 | 10 | 1 | small | 22.5 |
| 73 | 9 | 1.5 | 1 | 10 | 1 | small | 22.5 |
| 74 | 9 | 1.75 | 0.75 | 10 | 1 | small | 22.5 |
| 75 | 8 | 2.5 | 0.25 | 10 | 1 | small | 21.75 |
| 76 | 8 | 2.5 | 0.5 | 10 | 1 | small | 22 |
| 77 | 8 | 2.5 | 0.75 | 10 | 1 | small | 22.25 |
| 78 | 8 | 2.5 | 1 | 10 | 1 | small | 22.5 |
| 79 | 8 | 2.5 | 0.25 | 10 | 0.7 | small | 21.45 |
| 80 | 8 | 2.5 | 0.5 | 10 | 0.8 | small | 21.8 |
| 81 | 8 | 2.5 | 0.75 | 10 | 0.9 | small | 22.15 |
| 82 | 8 | 2.5 | 1 | 10 | 1 | small | 22.5 |
| 83 | 8 | 2.5 | 1.25 | 10 | 0.7 | small | 22.45 |
| 84 | 8 | 2.5 | 1.5 | 10 | 0.8 | small | 22.8 |
| 85 | 8 | 2.5 | 1.75 | 10 | 0.9 | small | 23.15 |
| 86 | 8 | 2.5 | 2 | 10 | 1 | small | 23.5 |
| 87 | 8 | 2.5 | 2.25 | 10 | 1 | ½ leaf | 23.75 |
| 88 | 8 | 2.5 | 2.5 | 10 | 1 | ½ leaf | 24 |
| 89 | 9 | 2.5 | 1.75 | 10 | 1 | ½ leaf | 24.25 |
| 90 | 9 | 2.5 | 2 | 10 | 1 | ½ leaf | 24.5 |
| 91 | 9 | 2.5 | 2.25 | 10 | 1 | ½ leaf | 24.75 |
| 92 | 8.64 | 2.5 | 1.875 | 10 | 0.9375 | | 23.9525 |
| 93 | 8.6571 | 2.5050 | 1.8787 | 10.0198 | 0.9394 | | 24 |

TABLE 4
Wild Blueberry Green Tea (WBGT) Results

| | Total | Citrus to | |
|---|---|---|---|
| Sample | Citrus | Monk Fruit | |
| No. | (mL) | Ratio | Taste Comments |
| 47 | 2.675 | 2.058 | |
| 48 | 4.09 | 3.146 | |
| 49 | 3.7 | 3.083 | |
| 50 | 5 | 4.808 | |
| 51 | 1.25 | 1.429 | not blueberry enough |
| 52 | 2.625 | 2.625 | too dilute |
| 53 | 2.5 | 4.808 | too dilute |
| 54 | 2.5 | 4.808 | too dilute |
| 55 | 4.375 | 4.667 | |
| 56 | 1.25 | 1.852 | |
| 57 | 1.925 | 1.54 | |
| 58 | 1.25 | 1.429 | |
| 59 | 5 | 4.808 | |
| 60 | 3.75 | 6 | |
| 61 | 5 | 4.808 | |
| 62 | 2.5 | 1.852 | |
| 63 | 2.5 | 3.333 | ok; not enough flavor |
| 64 | 2.5 | 2.5 | ok; not enough flavor |
| 65 | 2.5 | 2 | ok; not enough flavor |
| 66 | 2.5 | 1.667 | ok; not enough flavor |
| 67 | 2.5 | 2.5 | |
| 68 | 2.25 | 2.25 | too sweet |
| 69 | 2.5 | 2.5 | |
| 70 | 2.75 | 2.75 | |
| 71 | 2.5 | 2.5 | good blueberry; too sweet |
| 72 | 2.5 | 2.5 | |
| 73 | 2.5 | 2.5 | |
| 74 | 2.5 | 2.5 | |
| 75 | 2.75 | 2.75 | |
| 76 | 3 | 3 | |
| 77 | 3.25 | 3.25 | good; too sweet |
| 78 | 3.5 | 3.5 | good; too sweet |
| 79 | 2.75 | 3.929 | |
| 80 | 3 | 3.75 | |
| 81 | 3.25 | 3.611 | |
| 82 | 3.5 | 3.5 | |
| 83 | 3.75 | 5.357 | good |
| 84 | 4 | 5 | |
| 85 | 4.25 | 4.722 | very good |
| 86 | 4.5 | 4.5 | good |
| 87 | 4.75 | 4.75 | a bit sour |
| 88 | 5 | 5 | |
| 89 | 4.25 | 4.25 | really good; possibly too much mint |
| 90 | 4.5 | 4.5 | really good |
| 91 | 4.75 | 4.75 | |
| 92 | 4.375 | 4.667 | |
| 93 | 4.429 | 4.667 | |

### Example 3—Packaging

Packaging of the aqueous antioxidant compositions is achieved via a liquid filling-and-sealing machine. A hose is placed into a batch vessel containing a large batch of the aqueous antioxidant composition. A filling mechanism of the machine draws a set volume of the batch for a single package (21 g for LGT, 24 g for WBGT). A sealing mechanism of the machine takes a roll of PET/PE65 plastic film and creates closed-ended tubes from the film (via heat sealing), into which the desired volume of liquid is pumped through a funnel by the filling mechanism. Once filled, the open ends of the tubes are sealed, and the sealed tubes are placed into a metal apparatus sitting inside an ice-pop machine for flash freezing. The filled and sealed tubes are moved through the metal apparatus, which is sitting inside a propylene glycol bath at −25° to −28° C. Metal surfaces of the apparatus remove heat from the tubes until the aqueous compositions are frozen solid inside the sealed plastic tubes, which takes less than 20 minutes.

Packages after flash freezing have a length, including seals, of about 11.5 cm and a largest width, excluding seals, of about 1.8 cm, providing an aspect ratio of about 6.5:1. The seals at both ends of the tube are about 3 cm wide. Packages with frozen composition are removed from an opposite end of apparatus from which they enter, packed into cartons and then cases, and then stored in a freezer at −18° to −21° C.

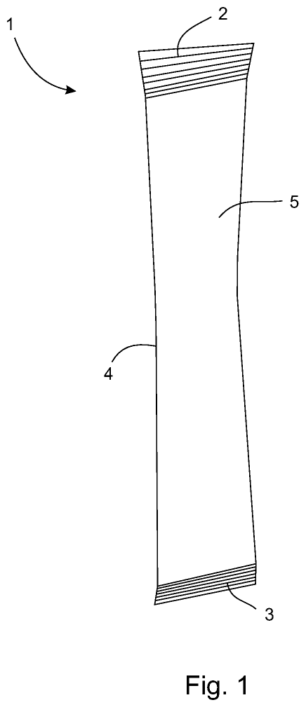

FIG. 1 illustrates a packaged frozen drink base 1 produced in accordance with the packaging method described above. The packaged frozen drink base 1 comprises a plastic tube 4 having a sealed first end 2 and a sealed second end 3, the plastic tube 4 filled with an unpasteurized frozen aqueous antioxidant composition 5.

### Example 4—Preparation of Beverages

Antioxidant beverages can be prepared from the aqueous antioxidant compositions by a variety of methods.

In a first method, one of the sealed ends of the packaged frozen antioxidant composition is cut open and inserted through the open mouth of a water bottle. The frozen antioxidant composition is squeezed into the water bottle by compressing the plastic tube. Water, for example 500 mL of water, is then added to the water bottle and the antioxidant composition is mixed and dissolved in the water.

In a second method, the packaged frozen antioxidant composition is thawed, and then one of the sealed ends of the thawed packaged antioxidant composition is cut open and inserted through the open mouth of a water bottle. The liquid antioxidant composition is poured into the water bottle, with the aid of squeezing the plastic tube if required. Water, for example 500 mL of water, is then added to the water bottle and the antioxidant composition is mixed and dissolved in the water.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A packaged frozen drink base comprising:
(a) an unpasteurized frozen aqueous antioxidant composition having a pH of 4 or less, the aqueous antioxidant composition consisting of:
i. a blueberry green tea (BGT) formulation consisting of citrus juice consisting of lemon juice and lime juice in an amount of 0.5-2.2 mL per 10 mL of the aqueous antioxidant composition, blueberry juice in an amount of 2.5-7.5 mL per 10 mL of the aqueous antioxidant composition, at least one natural sweetener in a v/v ratio of 3:1 to 6:1 citrus juice to sweetener, mint leaf extract, and green tea leaf extract in an amount of 3-6 mL per 10 mL of the aqueous antioxidant composition, or
ii. a lemon ginger turmeric (LGT) formulation consisting of citrus juice consisting of lemon juice in an amount of 6-8 mL per 10 mL of the aqueous antioxidant composition, at least one natural sweetener in a v/v ratio of 3:1 to 6:1 citrus juice to sweetener, ginger root extract in an amount of 0.1-0.55 mL per 10 mL of the aqueous antioxidant composition, and turmeric root extract in an amount of 0.5-1.2 mL per 10 mL of the aqueous antioxidant composition; and,
(b) packaging containing the unpasteurized frozen aqueous antioxidant composition, the packaging comprising a sealed waterproof tube having the aqueous antioxidant composition disposed therein, the sealed waterproof tube having an aspect ratio of length to largest diameter of at least 4:1.

2. The packaged frozen drink base of claim 1, wherein the at least one natural sweetener consists of monk fruit extract.

3. The packaged frozen drink base of claim 1, wherein the pH is 3 or less.

4. The packaged frozen drink base of claim 1, wherein the aqueous antioxidant composition is the BGT formulation, the at least one natural sweetener is present in an amount of 0.2-0.5 mL per 10 mL of the aqueous antioxidant composition, and the amount of citrus juice is 1.65-1.9 mL per 10 mL of the aqueous antioxidant composition.

5. The packaged frozen drink base of claim 4, wherein the blueberry juice is wild blueberry juice.

6. The packaged frozen drink base of claim 4, wherein the pH is 3 or less.

7. The packaged frozen drink base of claim 5, wherein the pH is 3 or less.

8. The packaged frozen drink base of claim 1, wherein:
the aqueous antioxidant composition is the BGT formulation;
the pH is 3 or less;
the at least one natural sweetener consists of monk fruit extract and is present in an amount of 0.2-0.5 mL per 10 mL of the aqueous antioxidant composition;
the amount of citrus juice is 1.65-1.9 mL per 10 mL of the aqueous antioxidant composition; and,
the aqueous antioxidant composition is flash frozen in the sealed waterproof tube.

9. The packaged frozen drink base of claim 1, wherein the aqueous antioxidant composition is the LGT formulation, the at least one natural sweetener is present in an amount of 1.5-1.8 mL per 10 mL of the aqueous antioxidant composition, and the amount of citrus juice is 7.0-7.6 mL per 10 mL of the aqueous antioxidant composition.

10. The packaged frozen drink base of claim 9, wherein the amount of turmeric root extract is 0.6-1 mL per 10 mL, and the amount of ginger root extract plus the amount of turmeric root extract is 1.5 mL or less per 10 mL of the aqueous antioxidant composition.

11. The packaged frozen drink base of claim 9, wherein the pH is 3 or less.

12. The packaged frozen drink base of claim 1, wherein:
the aqueous antioxidant composition is the LGT formulation;
the pH is 3 or less;
the at least one natural sweetener consists of monk fruit extract and is present in an amount of 1.5-1.8 mL per 10 mL of the aqueous antioxidant composition;
the amount of citrus juice is 1.65-1.9 mL per 10 mL of the aqueous antioxidant composition;
the amount of turmeric root extract is 0.6-1 mL per 10 mL of the aqueous antioxidant composition;
the amount of ginger root extract plus the amount of turmeric root extract is 1.5 mL or less per 10 mL of the aqueous antioxidant composition; and,
the aqueous antioxidant composition is flash frozen in the sealed waterproof tube.

13. The packaged frozen drink base of claim 1, wherein the aqueous antioxidant composition is flash frozen in the sealed waterproof tube.

14. The packaged frozen drink base of claim 1, wherein the aspect ratio is about 6.5:1.

15. The packaged frozen drink base of claim 1, wherein the waterproof tube comprises a plastic film.

16. A method of preparing a beverage, the method comprising opening the packaging of the drink base as defined in claim 1 and dissolving the aqueous antioxidant composition in water.

17. The method of claim 16, wherein the aqueous antioxidant composition is dissolved in 250-750 mL of the water.

18. An antioxidant beverage prepared from the packaged frozen drink base of claim 1.

19. The antioxidant beverage of claim 18, wherein the packaged frozen drink base is as defined in claim 8.

20. The antioxidant beverage of claim 18, wherein the packaged frozen drink base is as defined in claim 12.
